(19) United States
(12) Patent Application Publication
(10) Pub. No.: US 2017/0246731 A1
(43) Pub. Date: Aug. 31, 2017

(54) Locking Pliers

(71) Applicant: Ming-Chieh Wu, Taichung City (TW)

(72) Inventor: Ming-Chieh Wu, Taichung City (TW)

(21) Appl. No.: 15/593,532

(22) Filed: May 12, 2017

Related U.S. Application Data
(63) Continuation-in-part of application No. 14/485,884, filed on Sep. 15, 2014.
Application No. 14/485,884 is a continuation-in-part of application No. 13/469,469, filed on May 11, 2012, now Pat. No. 8,950,299.

(30) Foreign Application Priority Data
Jul. 12, 2011 (TW) 100124592

(51) Int. Cl. B25B 7/12

(52) U.S. Cl. CPC B25B 7/123

(57) ABSTRACT

A pair of locking pliers includes a fixed handle, a fixed jaw fixedly connected to the fixed handle and including a first edge with a plurality of asymmetrical first teeth extending therefrom and a second edge, a movable jaw pivotally connected to the fixed handle and including a third edge and a fourth edge with a plurality of asymmetrical second teeth extending therefrom, and a movable handle pivotally connected to the movable jaw.

### CROSS REFERENCE TO RELATED APPLICATION

The present application is a continuation-in-part application of U.S. patent application Ser. No. 14/485,884 filed on Sep. 15, 2014, of which the disclosure is incorporated herein.

### BACKGROUND OF THE INVENTION

1. Field of the Invention

This invention relates to a pair of locking pliers and, more particularly to a pair of locking pliers that resists slipping on a work piece.

2. Description of the Related Art

FIGS. 1 through 3 show a pair of locking pliers 10 includes a fixed handle 11, a fixed jaw 12 fixed to the fixed handle 11, a movable jaw 14 pivotally connected to the fixed handle 11 and pivotal about a first pivot 13, a movable handle 16 pivotally connected to the movable jaw 14 and pivotal a second pivot 15, and a toggle-link locking mechanism 17 configured to lock the movable jaw 14 in a closed, locked position. The fixed handle 11 has an oval slotted aperture 111. The first pivot 13 is movable in the aperture 111. A long axis of the aperture 111 is inclined at an angle a with respect to a line extending through the center of the closed jaws 12 and 14. The angle a is approximately 15 degrees. The locking mechanism 17 includes a link 173 pivotally connected to the movable handle 16 and abutting an adjustment screw 171. The locking mechanism 17 has a biasing member 172 interconnecting the movable jaw 14 and the fixed handle 11.

The pair of pliers can grip a work piece 20. Upon operating the pliers to grip the work piece 20, the movable jaw 14 rotates clockwise around the second pivot 15 toward the fixed jaw 12, and the first pivot 13 in the aperture 111 moves rearward, the movable jaw14 moves rearward and toward the fixed jaw 12, as indicated by arrows 21 and 22. Furthermore, the first pivot 13 moves to a rear end of the aperture 111 when the movable jaw 14 is locked.

It is noted that it is troublesome to design and make the aperture 111 allow a sliding engagement of the first pivot 13 to be stable. If the movement of the first pivot 13 is unstable, the gripping force is adversely affected and the pliers can not resist slipping on the work piece 20. Moreover, the aperture 111 has to be made precisely.

### SUMMARY OF THE INVENTION

The pair of locking pliers includes a fixed handle, a fixed jaw, a movable jaw, and a movable handle. The fixed jaw is fixedly connected to the fixed handle and includes a first clamping surface. The first clamping surface has a first edge and a second edge. The second edge extends rearward from the first edge. The first and second edges incline toward each other. The first edge includes a plurality of asymmetrical first teeth extending therefrom. Each first tooth includes a longer first profiled side and a shorter first profiled sick. The longer first profiled side extends along a first axis and inclines to the first edge at a first angle. The first angle is in a range between 25 degrees and 45 degrees. The movable jaw cooperates with the fixed jaw, has a first joining end pivotally connected to the fixed handle, and includes a second clamping surface. The second clamping surface has a third edge and a fourth edge. The fourth edge extends rearward from the third edge. The third and fourth edges incline toward each other. The fourth edge includes a plurality of asymmetrical second teeth extending therefrom. Each second tooth includes a longer second profiled side and a shorter second profiled side. The longer second profiled side extends along a second axis and inclines to the fourth edge at a second angle. The second angle is in a range between 25 and 45 degrees. The movable handle is pivotally connected to a second joining end of the movable jaw.

The movable jaw is pivoted toward closer to the fixed jaw upon operating the pair of locking pliers from initial, locking, to tightening positions.

The plurality of first teeth includes apexes thereof aligned along a third axis and the plurality of second teeth includes apexes thereof aligned along a fourth axis respectively, and wherein when the locking pliers is in the tightening position, the first and second axes intersect and include a first included angle of between 6 degrees and 20 degrees and the third and fourth axes intersect and have a second included angle of between 6 degrees and 20 degrees.

Other objectives, advantages, and new features of the present invention will become apparent from the following detailed description of the invention when considered in conjunction with the accompanied drawings.

### BRIEF DESCRIPTION OF THE DRAWINGS

FIGS. 1-3 are partial, cross-sectional views of a pair of conventional locking pliers;

FIG. 4 is a perspective view of the a pair of locking pliers according to this invention;

FIG. 5 is an exploded perspective view of the pair of locking pliers according to this invention;

FIG. 6 is a partial, cross-sectional view showing the pair of locking pliers of the present invention in an initial position;

FIG. 7 is a partial, cross-sectional view of the pair of locking pliers of the present invention in a tightening position;

FIG. 8 is a partial, enlarged view of the pair of locking pliers of the present invention in the tightening position;

FIG. 9 is another partial, cross-sectional view of the pair of locking pliers of the present invention in the tightening position;

FIG. 10 is a partial, cross-sectional view of the pair of locking pliers of the present invention in the tightening position and holding a work piece.

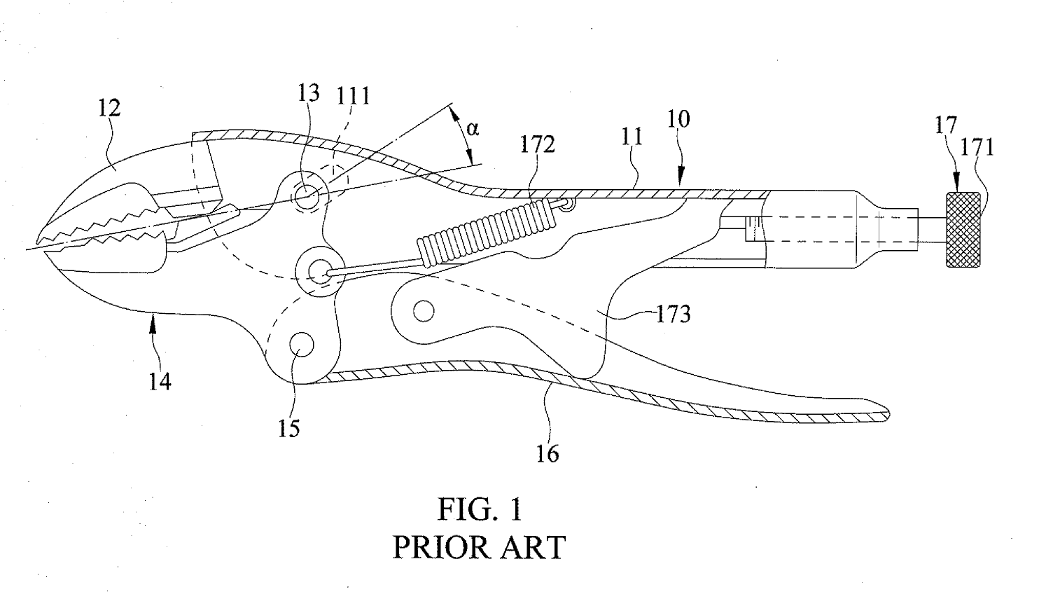

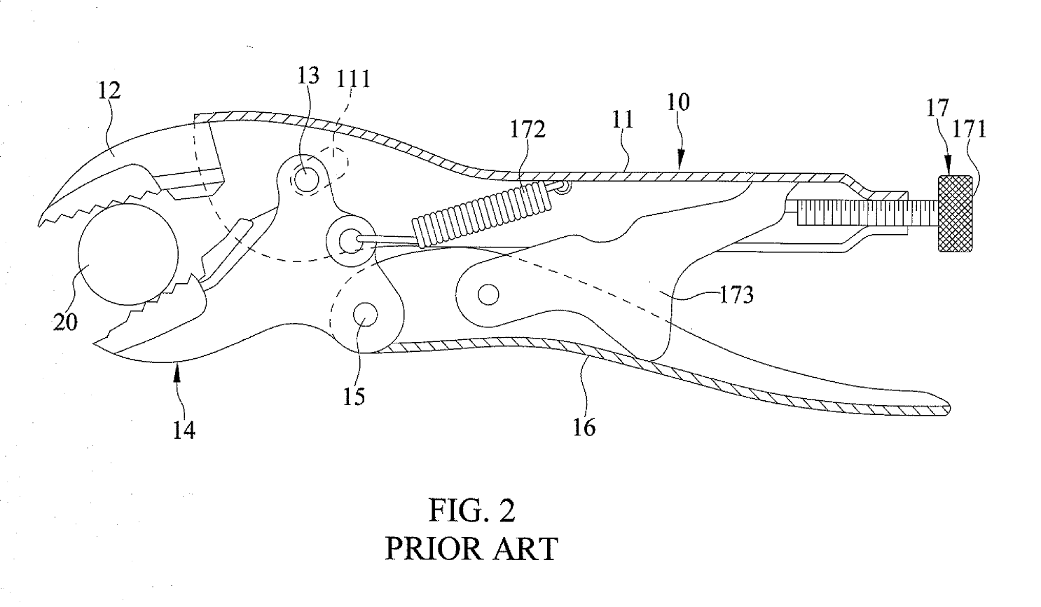

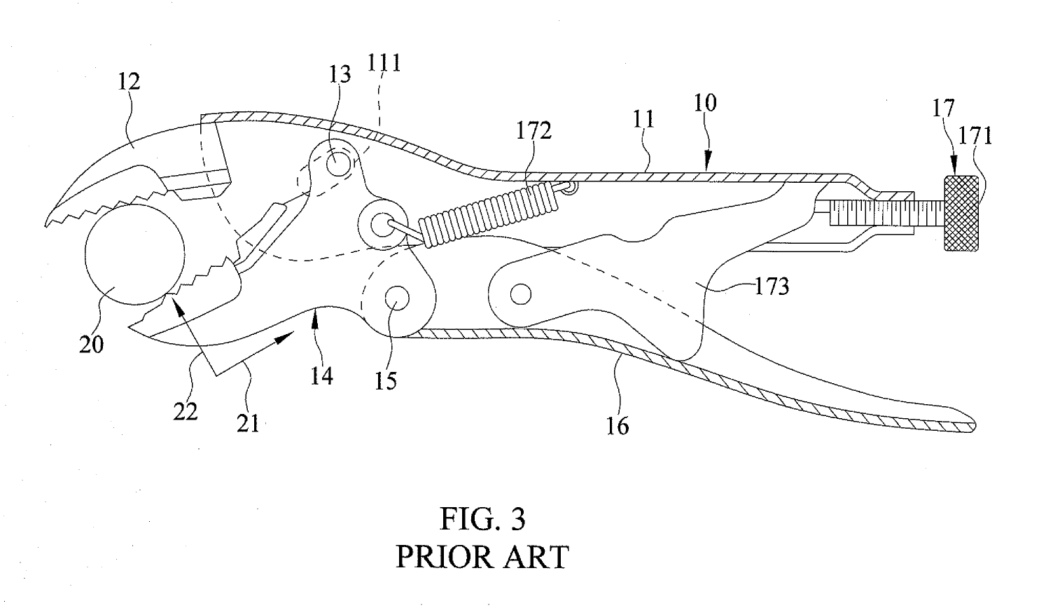

### DETAILED DESCRIPTION OF THE INVENTION

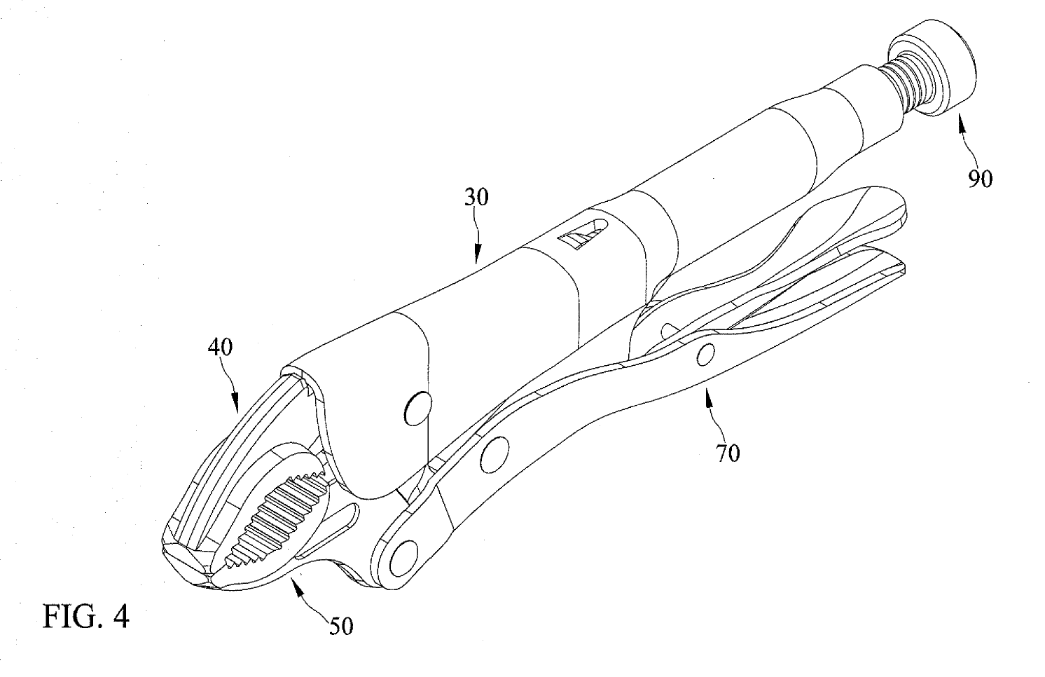

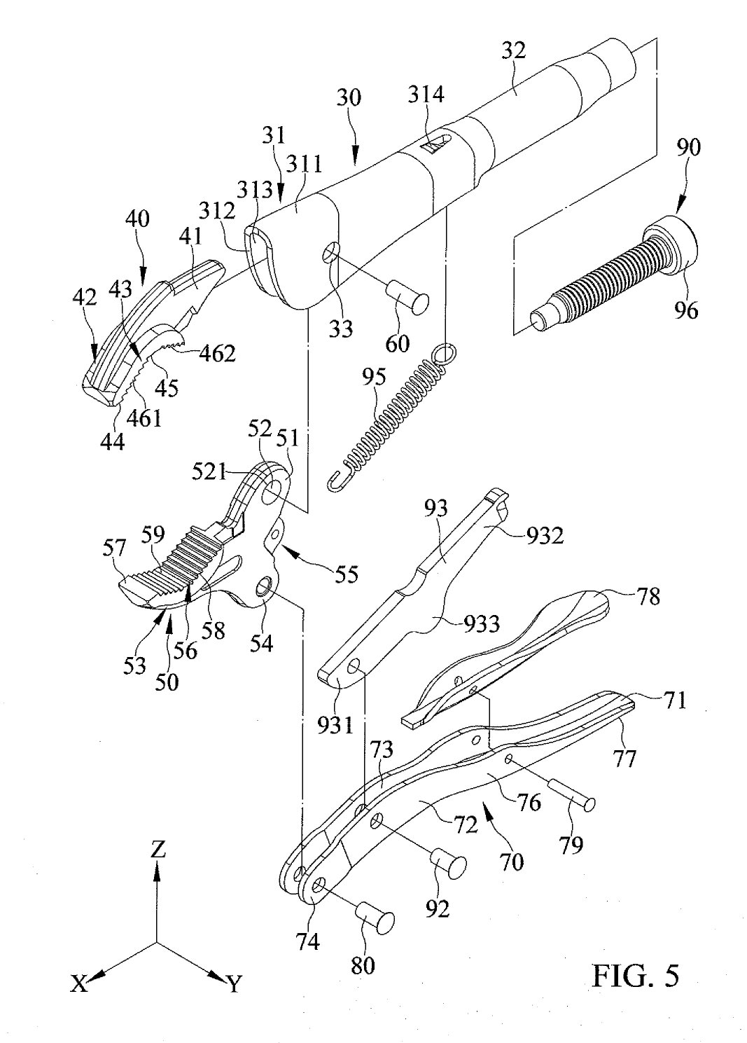

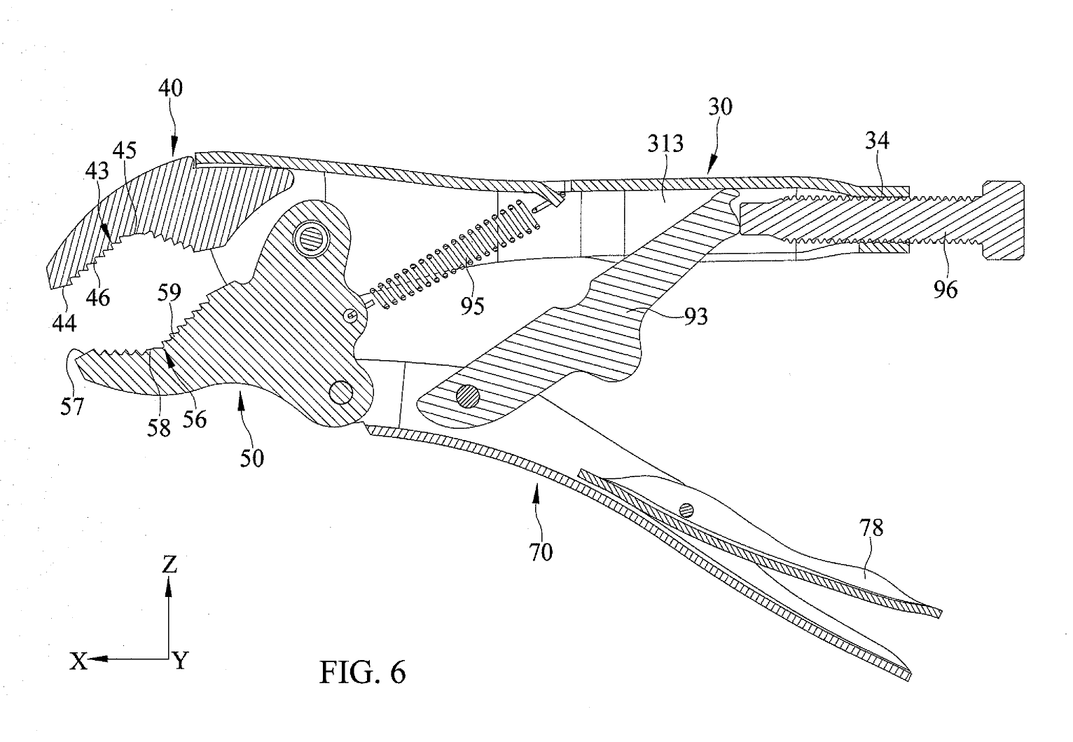

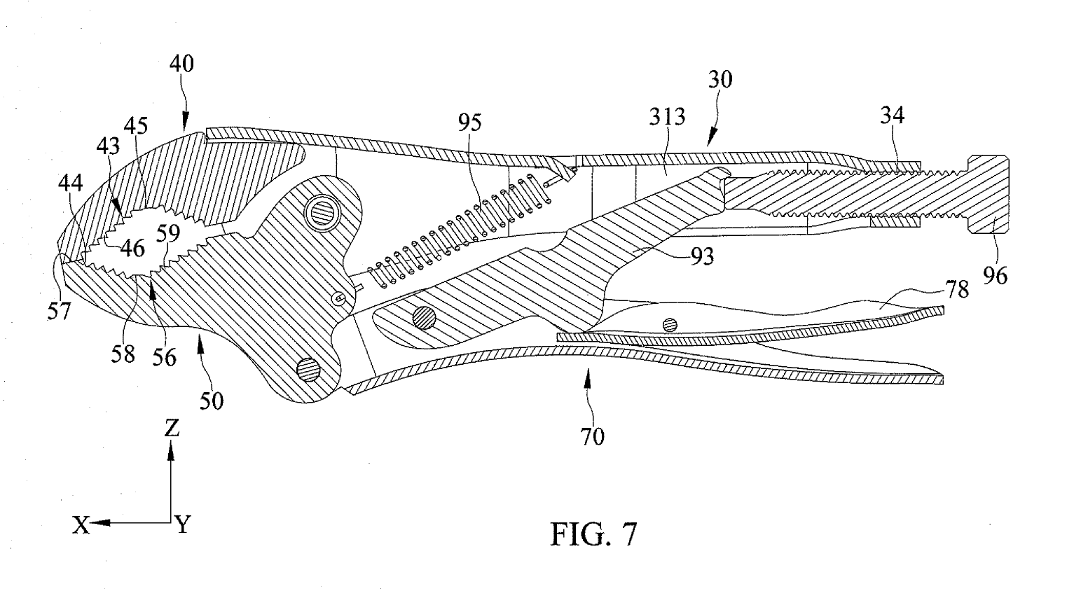

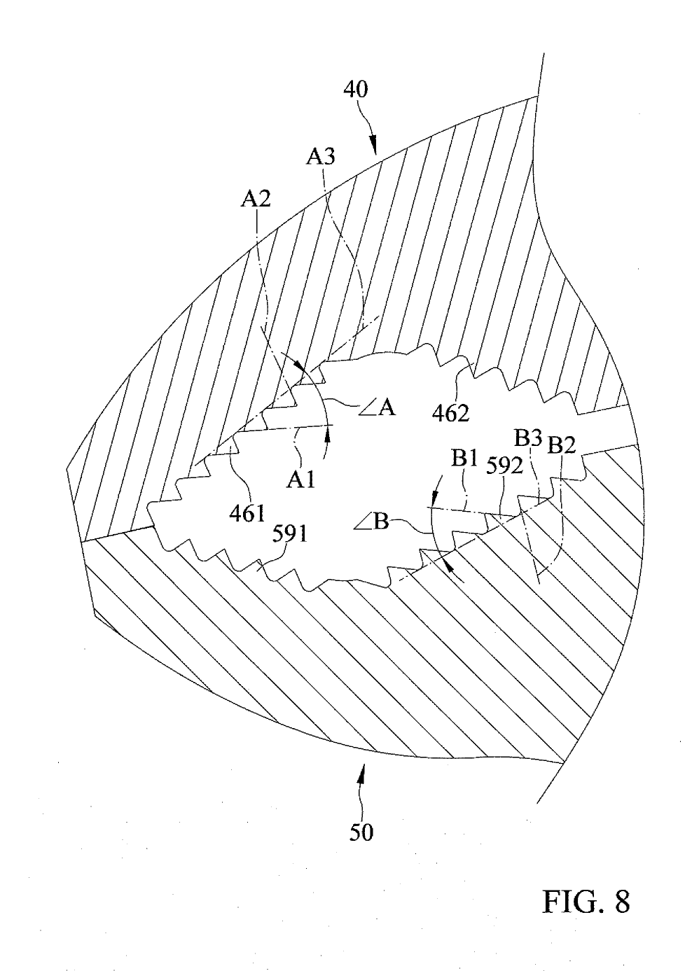

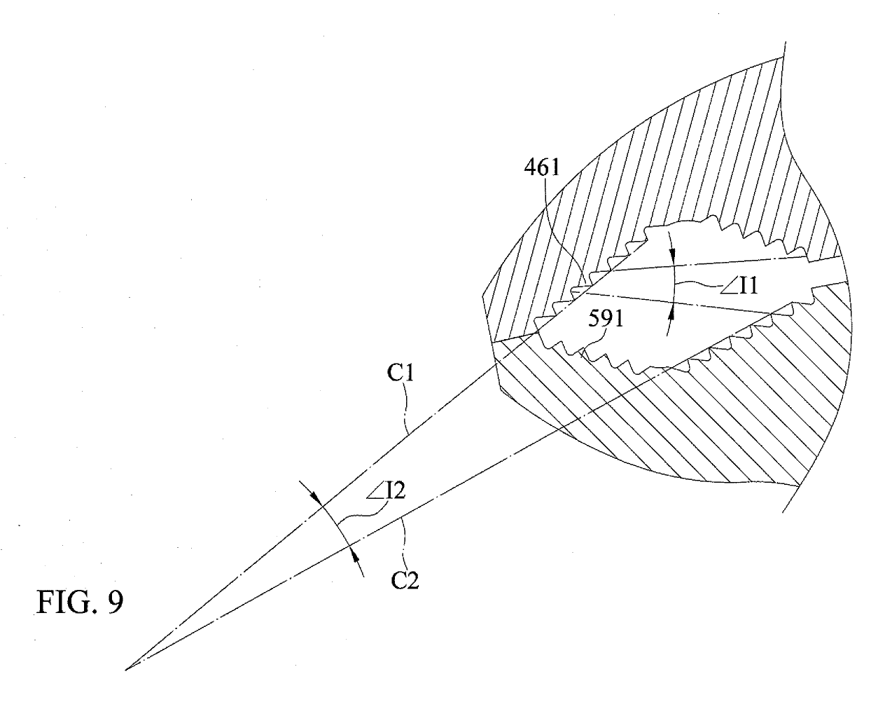

FIGS. 4 through 10 show a pair of locking pliers according to the present invention. The pair of locking pliers includes a fixed handle 30, a fixed jaw 40, a movable jaw 50, a movable handle 70, a biasing member 95, and a lock unit 90.

The fixed handle 30 has front and rear handle portions 31 and 32 and extends in a longitudinal direction X. A pivot hole 33 is formed on the front handle portion 31. A screw hole 34 is formed on the rear handle portion 32. In this embodiment, the front handle portion 31 is in the form of a grooved plate which includes an upper plate 311 and a pair of side plates 312. The pair of side plates 312 extends from the upper plate 311 in a transverse direction Z, which is transverse to the longitudinal direction X. The upper and side plates 311 and 312 cooperatively define a recess 313. The pivot and screw holes 33 and 34 are communicated with the recess 313. A tab 314 extends from the upper plate 311 and into the recess 313.

The fixed jaw 40 has a first connected portion 41 connected securely to the front handle portion 31. The fixed jaw 40 has a first working portion 42 extending forward, in the longitudinal direction X, from the first connected portion 41 and terminating at a first nose end 44. The first nose end 44 has a flat surface. The first working portion 42 has a first clamping surface 43 disposed rearward of, in the longitudinal direction X, the first nose end 44. The first clamping surface 43 is concaved. The first clamping surface 43 is formed with gripping teeth 46. The gripping teeth 46 extend after the first nose end 44 along a concaved contour 45. The gripping teeth 46 include a plurality of first teeth 461 and a plurality of second teeth 462. The plurality of first teeth 461 extends from a first edge of the first clamping surface 43. The plurality of second teeth 462 extends from a second edge of the first clamping surface 43. The first and second edges of the first clamping surface 43 incline toward each other. The first and second edges of the first clamping surface 43 are flat. The first edge of the first clamping surface 43 extends rearward of the first nose end 44 and toward the second edge of the first clamping surface 43. The second edge of the first clamping surface 43 extends rearward of the first edge and a transition edge of the first clamping surface 43. The transition edge of the first clamping surface 43 interconnects distal ends of the first and second edges of the first clamping surface 43. The plurality of first teeth 461 and the plurality of second teeth 462 are different in shape. Each of the plurality of first teeth 461 has an asymmetric profile including two profiled sides, which includes a longer first profiled side and a shorter second profiled side. The first and second profiled sides of each of the plurality of first teeth 461 respectively has first and second lengths measured from the first edge of the first clamping surface 43 to an apex of each of the plurality of first teeth 461. The first and second profiled sides of each of the plurality of first teeth 461 extend toward the apex of each of the plurality of first teeth 461. The apex of each of the plurality of first teeth 461 is pointed. The apexes of the plurality of first teeth 461 are aligned axially. The first profiled side of each of the plurality of first teeth 461 extends along an axis A1 and inclines to the first edge, i.e., the first edge extends along an axis A3, at an angle A. The angle A is in a range between 25 and 45 degrees. The second profiled side of each of the plurality of first teeth 461 extends along an axis A2. An included angle between axes A1 and A2 is greater than 60 degrees. Each of the plurality of second teeth 462 has a symmetric profile including two profiled sides the same in length. First and second profiled sides of each of the plurality of second teeth 462 respectively has first and second lengths measured from the second edge of the first clamping surface 43 to an apex of each of the plurality of second teeth 462. The first and second profiled sides of each of the plurality of second teeth 462 incline toward the apex of each of the plurality of second teeth 462. The apex of each of the plurality of second teeth 462 is pointed. The apexes of the plurality of second teeth 462 are aligned axially.

The movable jaw 50 has a second connected portion 55 extending in the transverse direction Z. The second connected portion 55 terminates and includes first and second joining ends 51 and 54. The movable jaw is 50 is pivotally connected to the fixed handle 30 and is pivotal about a pivot 60. The movable jaw 50 includes a pivot hole 52, and the pivot 60 engages in the pivot hole 52. The pivot hole 52 has an inner periphery defining an inner tubular surface 521. The inner tubular surface 521 has a circular contour. The pivot 60 also engages with the front handle portion 31 through the pivot. hole 33. The movable jaw 50 has a second working portion 53 extending forward of, in the longitudinal direction X, the second connected portion 55 and terminating at a second nose end 57. The second nose end 57 is a flat surface. The second working portion 53 has a second clamping surface 56 disposed rearward of, in the longitudinal direction X, the second nose end 57. The second clamping surface 56 is concaved. The second clamping surface 56 is formed with gripping teeth 59. The gripping teeth 59 extend after the second nose end 57 and along a concaved contour 58. The gripping teeth 59 include a plurality of first teeth 591 and a plurality of second teeth 592. The plurality of first teeth 591 extends from a first edge of the second clamping surface 56. The plurality of second teeth 592 extends from a second edge of the second clamping surface 56. The first edge of the first clamping surface 43 is disposed more adjacent to a front distal end of the pair of locking pliers than the second edge of the second clamping surface 56. The first and second edges of the second clamping surface 56 are flat. The first edge of the second clamping surface 56 extends rearward of the second nose end 57 toward the second edge of the second clamping surface 56. The second edge of the second clamping surface 56 extends rearward of the first edge and a transition edge of the second clamping surface 56. The transition edge of the second clamping surface 56 interconnects distal ends of the first and second edges of the second clamping surface 56. The first and second edges of the second clamping surface 56 incline toward each other. The plurality of first teeth 591 and the plurality of second teeth 592 are different in shape. Each of the plurality of first teeth 591 has a symmetric profile including two profiled sides the same in length. First and second profiled sides of each of the plurality of first teeth 591 respectively has first and second lengths measured from the first edge of the second clamping surface 56 to an apex of each of the plurality of first teeth 591. The first and second profiled sides of each of the plurality of first teeth 591 incline toward the apex of each of the plurality of first teeth 591. The apex of each of the plurality of first teeth 591 is pointed. The apexes of the plurality of first teeth 591 are aligned axially. Each of the plurality of second teeth 592 has an asymmetric profile including a longer first profiled side and a second shorter profiled side. The first and second profiled sides of each of the plurality of second teeth 592 respectively has first and second lengths measured from the second edge of the second clamping surface 56 to an apex of each of the plurality of second teeth 592. The first and second profiled sides of each of the plurality of second teeth 592 incline toward the apex of each of the plurality of second teeth 592. The apex of each of the plurality of second teeth 592 is pointed. The apexes of the plurality of second teeth 592 are aligned axially. The first profiled side of each of the plurality of second teeth 592 extends on an axis B1 and inclines to the second edge, i.e., the second edge extends along an axis B3, at an angle B. The angle B is in a range between 25 and 45 degrees. The second profiled side of each of the plurality of second teeth 592 extends on an axis B2. An included angle between axes B1 and B2 is greater than 60 degrees.

The movable handle 70 has a front pivot portion 74 pivotally connected to the second joining end 54 and is pivotal about a pivot 80. The movable handle 70 has a rear actuating portion 76 extending rearward of the front pivot portion 74, in the longitudinal direction X, and terminating at a movable handle end 77. In this embodiment, the movable handle 70 is in the form of a grooved plate including a base seat 71 and a pair of side plates 72. The pair of side plates 72 extends from the base seat 71 in the transverse direction Z and is spaced apart from each other in the axial direction Y. The base seat 71 and the pair of side plates 72 cooperatively define a concavity 73.

The biasing member 95 interconnects the fixed handle 30 and the movable jaw 50. The biasing member 95 has one end connected to the tab 314 and another end connected to the second connected portion 55 respectively. Therefore, the fixed handle 30 and the movable jaw 50 are subject to a tensional force of the biasing member 95. The biasing member 95 is released from tension when the pair of locking pliers is in the initial position thereof. In this embodiment, the biasing member 95 is a tension spring.

The lock unit 90 is a toggle locking assembly. The lock unit includes a toggle link 93 interconnecting the fixed and movable handles 30 and 70. The toggle link 93 has a proximal end 931 pivotally connected to the movable handle 70 and is pivotal about a pivot 92. The toggle link 93 has a second distal end 932 disposed in the recess 313 and slidably retained on the rear handle portion 32. The second distal end 932 of the toggle link 93 is in contact with an adjustment screw 96. The adjustment screw 96 is threadedly engaged with the screw hole 9. The toggle link 93 has a protrusion 933 extending rearward to serve as a stop. The adjustment screw 96 can be operated to adjust a separating distance between the fixed and movable jaws 40 and 50.

The second clamping surface 56 is close, closer and closest to the first clamping surface 43 respectively upon changing locking pliers among initial, locking, and tightening positions thereof, as will be described hereinafter.

When the pair of locking pliers is in the initial position, the movable handle 70 is disposed away from the fixed handle 30.

The movable handle 70 moves toward the fixed handle 30 upon moving the pair of locking pliers from the initial position to the tightening position. Furthermore, the second nose end 57 abuts the first nose end 44 when the pair of locking pliers in the locking position. Furthermore, the axes A1 and B1 intersect and include a first included angle I1 of between 6 degrees and 20 degrees when the pair of locking pliers is in the tightening position. Moreover, the apexes of the plurality of first teeth 461 align along a axis C1 and the apexes of the plurality of second teeth 592 align along a axis C2 respectively, and the axes C1 and C2 intersect and have a second included angle 12 of between 6 degrees and 20 degrees.

In addition, a release lever 78 releasably engages with the toggle link 93 and is pivotally connected to the movable handle 70. The release lever 78 is received by the concavity 73. The protrusion 933 of the toggle link 93 is disposed away from the release lever 78 when the pair of locking pliers is in the initial position. Furthermore, the protrusion 933 is disposed on release lever 78 when the pair of locking pliers is in the tightening position.

When the pair of locking pliers is in the tightening position, the toggle link 93 is locked in place and prevents the movable jaw 50 from pivoting away from the fixed jaw 40 inadvertently. Furthermore, a user can use the release lever 78 to raise the toggle link 93 and facilitates release of the toggle link 93. After the toggle link 93 is released, the pair of locking pliers returns to the initial position.

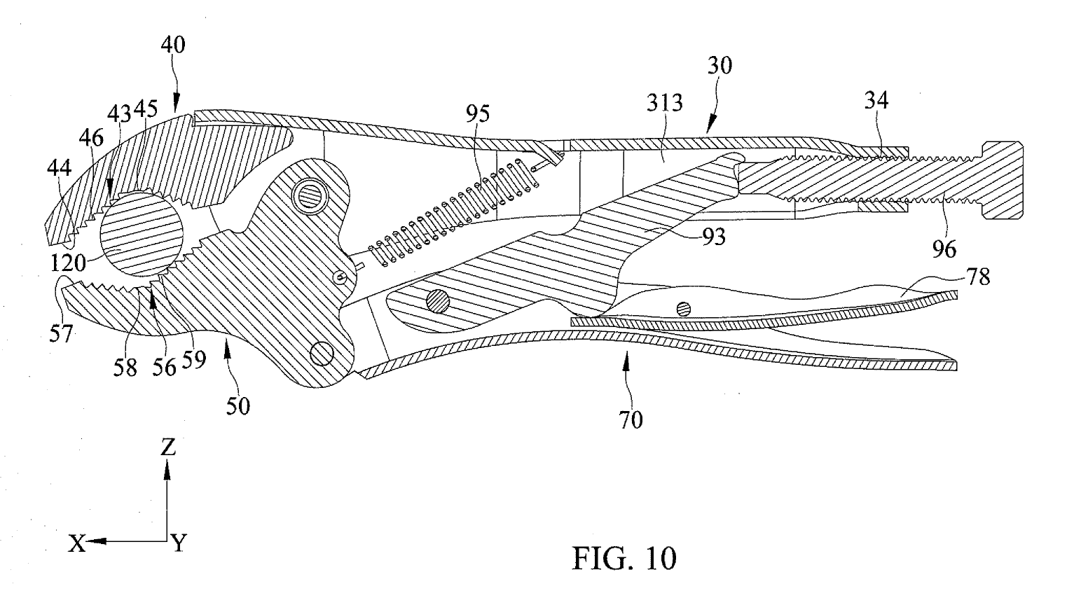

In view of the forgoing, the pair of locking pliers in the tightening position is able to grip a work piece 120. FIG. 10 shows that the work piece 120 is firmly held by the asymmetrical teeth 461 and 592. Firmly means that the pair of locking pliers resists slipping on the work piece 120. Firmly means that the pair of locking pliers will not slip over the work piece 120 at higher applied torques.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

What is claimed is:

1. A pair of locking pliers comprising:
a fixed handle;
a fixed jaw fixedly connected to the fixed handle and including a first clamping surface, with the first clamping surface having a first edge and a second edge, with the second edge extending rearward from the first edge, with the first and second edges inclining toward each other, with the first edge including a plurality of asymmetrical first teeth extending therefrom, with each first tooth including a longer first profiled side and a shorter first profiled side, with the longer first profiled side extending along a first axis and inclined to the first edge at a first angle, and with the first angle in a range between 25 degrees and 45 degrees;
a movable jaw cooperating with the fixed jaw, having a first joining end pivotally connected to the fixed handle, and including a second clamping surface, with the second clamping surface having a third edge and a fourth edge, with the fourth edge extending rearward from the third edge, with the third and fourth edges inclining toward each other, with the fourth edge including a plurality of asymmetrical second teeth extending therefrom, with each second tooth including a longer second profiled side and a shorter second profiled side, with the longer second profiled side extending along a second axis and inclined to the fourth edge at a second angle, and with the second angle in a range between 25 and 45 degrees; and
a movable handle pivotally connected to a second joining end of the movable jaw;
wherein the movable jaw is pivoted toward closer to the fixed jaw upon operating the pair of locking pliers from initial, locking, to tightening positions; and
wherein the plurality of first teeth includes apexes thereof aligned along a third axis and the plurality of second teeth includes apexes thereof aligned along a fourth axis respectively, and wherein when the locking pliers is in the tightening position, the first and second axes intersect and include a first included angle of between 6 degrees and 20 degrees and the third and fourth axes intersect and have a second included angle of between 6 degrees and 20 degrees.

2. The locking pliers as claimed in claim 1 further comprising a lock unit including a toggle link having a proximal end pivotally connected to the movable handle and a distal end slidably retained on the fixed handle, a biasing member interconnecting the fixed handle and the movable jaw, and an adjustment screw disposed on the fixed handle and abutting the distal end of the toggle link.

3. The locking pliers as claimed in claim 1, wherein the second edge includes a plurality of symmetrical third teeth extending therefrom, and wherein the third edge includes a plurality of symmetrical fourth teeth extending therefrom.

4. The locking pliers as claimed in claim 1, wherein the first and second clamping surfaces are concaved.

5. The locking pliers as claimed in claim 1 further comprising a release lever releasably engaging with the toggle link and pivotally connected to the movable handle, wherein the toggle link includes a protrusion disposed away from the release lever when the locking pliers is in the initial position, and wherein the protrusion is disposed on release lever when the locking pliers is in the tightening position.

6. The locking pliers as claimed in claim 5, wherein the movable handle includes a base seat and a pair of side plates cooperating to form a concavity, wherein the release lever is received by the concavity.

7. The locking pliers as claimed in claim 1, wherein the fixed jaw includes a nose end disposed forward of the first clamping surface and the movable jaw includes a second nose end disposed forward of the second clamping surface respectively, wherein the first and second nose ends abut with each other when the pair of locking pliers is in the tightening position.

8. The locking pliers as claimed in claim 1, wherein apexes of the plurality of first and second teeth are pointed.

9. The locking pliers as claimed in claim 3, wherein each third teeth has an apex and includes two symmetrical profiled sides inclined toward the apex thereof, wherein the apexes of the plurality of third teeth are pointed, wherein each fourth teeth has an apex and includes two symmetrical profiled sides profiled sides inclined toward the apex thereof, and wherein the apexes of the plurality of fourth teeth are pointed.

10. The pair of locking pliers as claimed in claim 1, wherein the first edge of the first clamping surface is disposed more adjacent to a front distal end of the pair of locking pliers than the fourth edge of the second clamping surface.

11. The locking pliers as claimed in claim 2, wherein the second edge includes a plurality of symmetrical third teeth extending therefrom, and wherein the third edge includes a plurality of symmetrical fourth teeth extending therefrom.

12. The locking pliers as claimed in claim 2, wherein the first and second clamping surfaces are concaved.

13. The locking pliers as claimed in claim 2 further comprising a release lever releasably engaging with the toggle link and pivotally connected to the movable handle, wherein the toggle link includes a protrusion disposed away from the release lever when the locking pliers is in the initial position, and wherein the protrusion is disposed on release lever when the locking pliers is in the tightening position.

14. The locking pliers as claimed in claim 13, wherein the movable handle includes a base seat and a pair of side plates cooperating to form a concavity, wherein the release lever is received by the concavity.

15. The locking pliers as claimed in claim 2, wherein the fixed jaw includes a nose end disposed forward of the first clamping surface and the movable jaw includes a second nose end disposed forward of the second clamping surface respectively, wherein the first and second nose ends abut with each other when the pair of locking pliers is in the tightening position.

16. The locking pliers as claimed in claim 2, wherein apexes of the plurality of first and second teeth are pointed.

17. The locking pliers as claimed in claim 11, wherein each third teeth has an apex and includes two symmetrical profiled sides inclined toward the apex thereof, wherein the apexes of the plurality of third teeth are pointed, wherein each fourth teeth has an apex and includes two symmetrical profiled sides profiled sides inclined toward the apex thereof, and wherein the apexes of the plurality of fourth teeth are pointed.

18. The pair of locking pliers as claimed in claim 2, wherein the first edge of the first clamping surface is disposed more adjacent to a front distal end of the pair of locking pliers than the fourth edge of the second clamping surface.
